(19) United States
(12) Patent Application Publication
(10) Pub. No.: US 2007/0005706 A1
(43) Pub. Date: Jan. 4, 2007

(54) Maintaining the integrity of a copy list

(75) Inventors: Steven Joseph Branda, Rochester, MN (US); John Joseph Stecher, Rochester, MN (US); Robert Wisniewski, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/154,875

(22) Filed: Jun. 16, 2005

(51) Int. Cl. G06F 15/16

(52) U.S. Cl. 709/206

(57) ABSTRACT

A method, apparatus, system, and signal-bearing medium that, in an embodiment, determine that a second e-mail is associated with a first e-mail and that one of the recipients of the first e-mail was a blind-copy recipient, and, in response, send the second e-mail to the blind-copy recipient of the first e-mail. In various embodiments, the second e-mail may be a reply to or a forward of the first e-mail. In an embodiment, the second e-mail has an encrypted portion, which includes an identifications of the blind-copy recipient, the sender of the first e-mail, and the other recipients of the first e-mail. The blind-copy recipient of the first e-mail is not identified in the first e-mail to the other recipients of the first e-mail. In this way, blind-copy recipients of e-mails may be notified of further associated e-mails.

### FIELD

An embodiment of the invention generally relates to e-mail (electronic-mail). In particular, an embodiment of the invention generally relates to maintain the integrity of a copy list in e-mail.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware components (such as semiconductors, integrated circuits, programmable logic devices, programmable gate arrays, power supplies, electronic card assemblies, sheet metal, cables, and connectors) and software, also known as computer programs.

Years ago, computers were isolated devices that did not communicate with each other. But, today computers are often connected in networks. One such network is the Internet or World Wide Web, in which electronic document transfer and message communication such as electronic mail (e-mail) are commonplace. More and more users globally are communicating via e-mail, which is considerably less expensive and more convenient than telephone calls, faxes, or letters.

Users of e-mail in the Internet are typically provided with a user e-mail address, which serves as an electronic mail box. A user is able to create an e-mail and transmit it to one or more other users via their respective user address. Messages are thus capable of being transmitted to multiple recipients, simultaneously. This is usually accomplished when the sender or originator of the e-mail enters the respective addresses of each desired recipient in a destination address location (e.g., the “TO,” “CC,” or “BCC” fields) of the user interface provided by the e-mail application software being utilized to transmit the e-mail.

Users employ the “BCC” (blind carbon copy) field to send a copy of the e-mail to a specified recipient without the knowledge of the other recipients specified in the TO field and the optional CC field. Senders of e-mail often employ the BCC field if the content of the e-mail is particularly important, controversial, or confrontational, and they wish to notify a manager or a co-worker of the e-mail content without arousing suspicion or inquiry from the other recipients. In other examples, the BCC field is used because the other recipients have no need to know the name of the person in the BCC field, or would not recognize the name and would wonder why an unrecognized person (e.g., a secretary or other administrative personnel) is receiving the e-mail. In yet another example, senders of mass e-mails often specify only their own e-mail address in the TO field (sending the e-mail to themselves) and specify all the rest of the recipients in the BCC field, thus keeping the entire distribution list confidential. In order to implement the BCC field, mail servers typically remove this field from the e-mail prior to forwarding it to the recipients.

Since the BCC field is removed from the e-mail, any further forwarding of or replying to the e-mail is not automatically sent to the original BCC recipient(s). This means that the original sender of the e-mail must remember to manually forward any further e-mails at a later time to the original BCC recipient(s). Relying on the original sender to forward further e-mails to the original BCC recipient(s) leads to the possibility that the original sender will forget to forward the e-mails or will intentionally or inadvertently alter the further e-mails prior to forwarding, and results in a larger amount of e-mail traffic and more storage used on the sender's computer.

What is needed is a technique that allows the original BCC recipient to receive the full thread of e-mail discussion between those recipients for whom the e-mail was addressed, as well as the original sender.

### SUMMARY

A method, apparatus, system, and signal-bearing medium are provided that, in an embodiment, determine that a second e-mail is associated with a first e-mail and that one of the recipients of the first e-mail was a blind-copy recipient, and, in response, send the second e-mail to the blind-copy recipient of the first e-mail. In various embodiments, the second e-mail may be a reply to or a forward of the first e-mail. In an embodiment, the second e-mail has an encrypted portion, which includes an identifications of the blind-copy recipient, the sender of the first e-mail, and the other recipients of the first e-mail. The blind-copy recipient of the first e-mail is not identified in the first e-mail to the other recipients of the first e-mail. In this way, blind-copy recipients of e-mails may be notified of further associated e-mails.

### BRIEF DESCRIPTION OF THE DRAWING

FIG. 1 depicts a block diagram of an example system for implementing an embodiment of the invention.

FIG. 2A depicts a block diagram of an example e-mail, as initially created at a client, according to an embodiment of the invention.

FIG. 2B depicts a block diagram of the example e-mail, as modified by the client, according to an embodiment of the invention.

FIG. 2C depicts a block diagram of a forwarded example e-mail, according to an embodiment of the invention.

FIG. 3 depicts a flowchart of example processing for a client controller, according to an embodiment of the invention.

FIG. 4 depicts a flowchart of example processing for a mail server, according to an embodiment of the invention.

### DETAILED DESCRIPTION

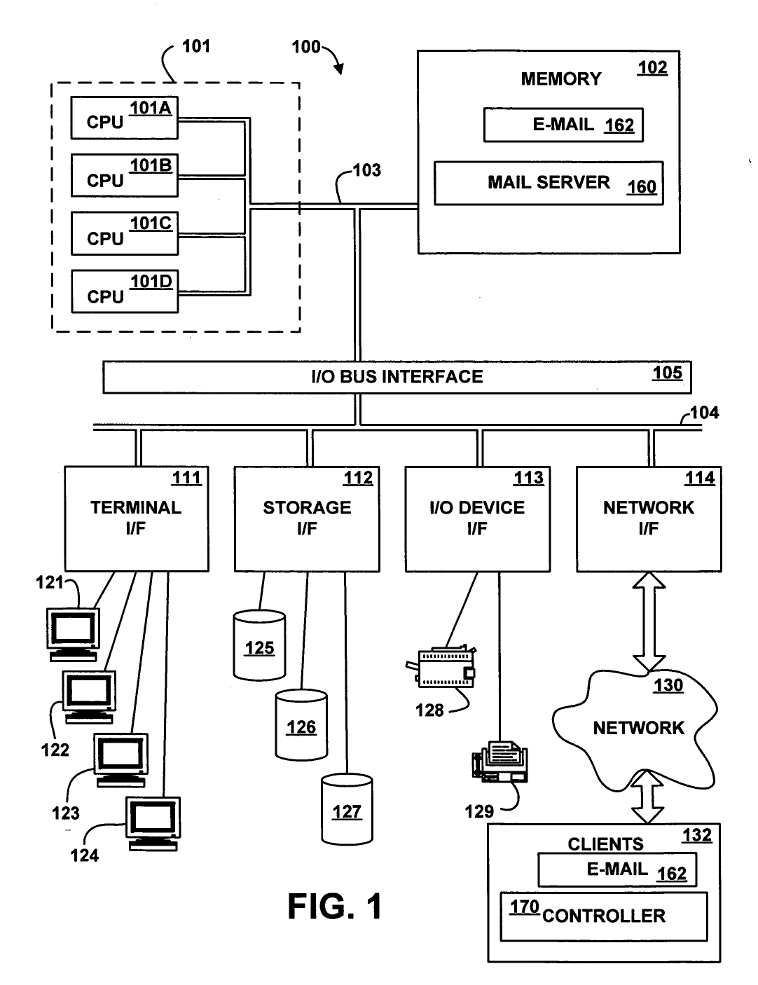

Referring to the Drawings, wherein like numbers denote like parts throughout the several views, FIG. 1 depicts a high-level block diagram representation of a server computer system 100 connected via a network 130 to clients 132, according to an embodiment of the present invention. The terms “computer,” “client,” and “server” are used herein for convenience only, and an electronic device that acts as a server in one embodiment may act as a client in another embodiment, and vice versa. In an embodiment, the hardware components of the computer system 100 may be implemented by an eServer iSeries computer system available from International Business Machines of Armonk, N.Y. However, those skilled in the art will appreciate that the mechanisms and apparatus of embodiments of the present invention apply equally to any appropriate computing system.

The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing data and programs. In another embodiment, the main memory 102 represents the entire virtual memory of the computer system 100, and may also include the virtual memory of other computer systems coupled to the computer system 100 or connected via the network 130. The main memory 102 is conceptually a single monolithic entity, but in other embodiments the main memory 102 is a more complex arrangement, such as a hierarchy of caches and other memory devices. For example, the main memory 102 may exist in multiple levels of caches, and these caches may be further divided by function, so that one cache holds instructions while another holds non-instruction data, which is used by the processor or processors. The main memory 102 may be further distributed and associated with different CPUs or sets of CPUs, as is known in any of various so-called non-uniform memory access (NUMA) computer architectures.

The main memory 102 includes a mail server 160 and an e-mail 162. The computer system 100 may use virtual addressing mechanisms that allow the programs of the computer system 100 to behave as if they only have access to a large, single storage entity instead of access to multiple, smaller storage entities. Thus, while the mail server 160 and the e-mail 162 are illustrated as being contained within the main memory 102, these elements are not necessarily all completely contained in the same storage device at the same time.

The mail server 160 receives the e-mail 162 from a client 132 and routes the e-mail 162 to its intended destination(s), such as other of the clients 132. The mail server 160 may also be known as a mail transfer agent (MTA) or a mail exchange server. In an embodiment, the mail server 160 and the computer system 100 may be implemented as part of an Internet Service Provider (ISP), but in other embodiments, the mail server 160 and the computer system 100 may be implemented as any appropriate service that routes e-mail between the clients 132.

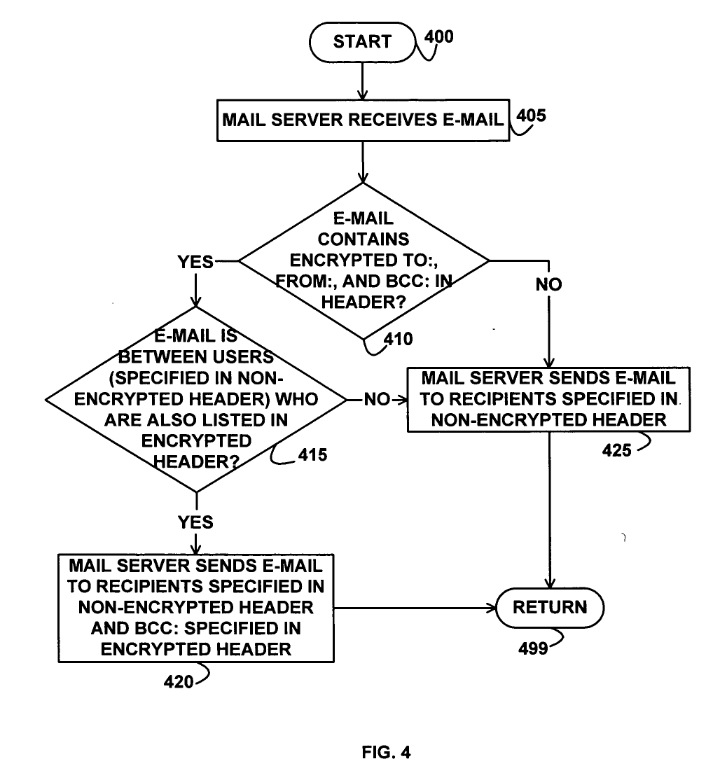

The mail server 160 includes instructions capable of executing on the processor 101 or statements capable of being interpreted by instructions executing on the processor 101 to perform the functions as further described below with reference to FIG. 4. In another embodiment, the mail server 160 may be implemented in microcode or firmware. In another embodiment, the mail server 160 may be implemented in hardware via logic gates and/or other appropriate hardware techniques in lieu of or in addition to a processor-based system.

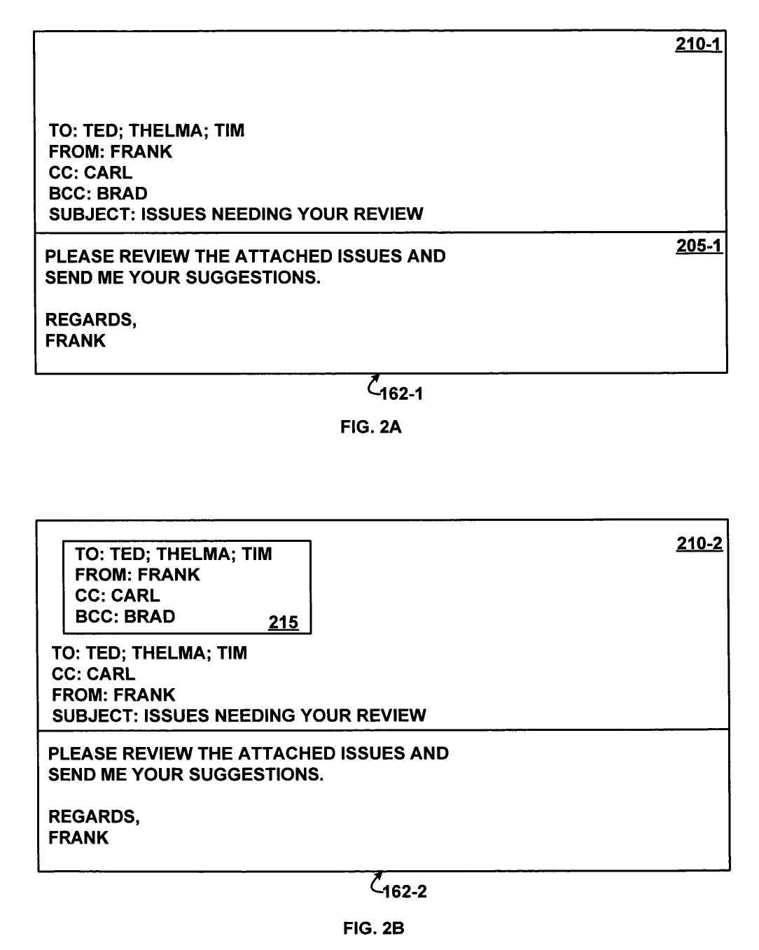

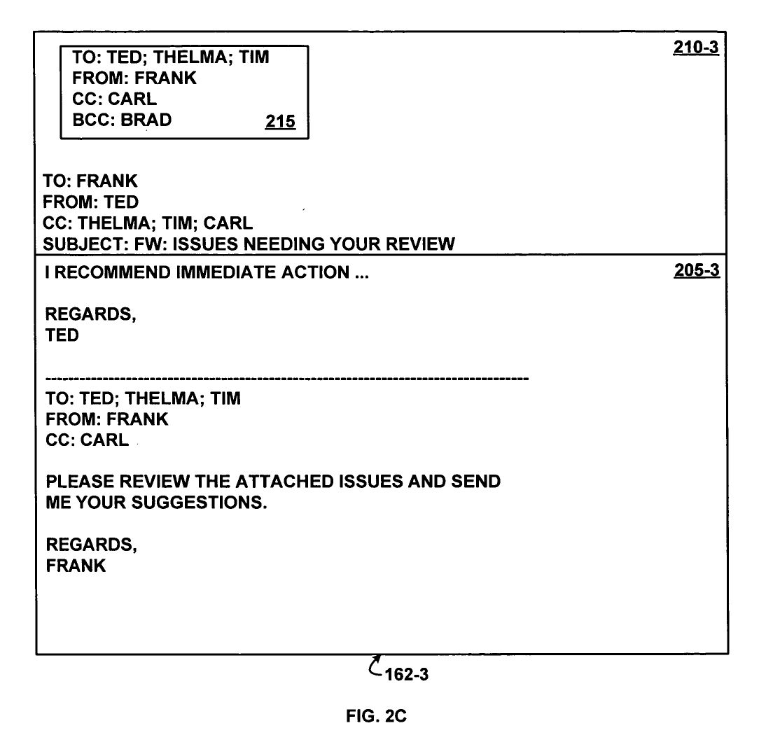

The e-mail (electronic mail) 162 may include text messages, optional file attachments, graphics, or video, and is capable of being transmitted over the network 130 between the clients 132 via the mail server 160. The e-mail 162 is further described below with reference to FIGS. 2A, 2B, and 2C.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI bus, or any other appropriate bus technology.

The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127, as needed.

The I/O and other device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100 and the clients 132. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol).

In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number (including zero) of networks (of the same or different types) may be present.

The clients 132 may include some or all of the hardware and/or software elements previously described above for the computer system 100. Although the clients 132 are illustrated as being separate from the computer system 100, in other embodiments some or all of the clients 132 and the computer system 100 may be the same electronic device. The client 132 includes a controller 170 and an e-mail 162. The controller 132 is an application that enables the sending, receiving, and optional organizing of e-mail. The controller 170 sends e-mail to the mail server 160 and receives e-mail from the mail server 160. In various embodiments, the controller 170 may be implemented as a web browser, mail client, or any other appropriate type of program. In various embodiments, the controller 170 and/or the mail server 160 may use POP3 (Post Office Protocol 3), IMAP (Internet Message Access Protocol), IMAP4 (Internet Message Access Protocol 4), SMTP (Simple Mail Transfer Protocol), or other any other appropriate protocol for sending and/or receiving the e-mail 162.

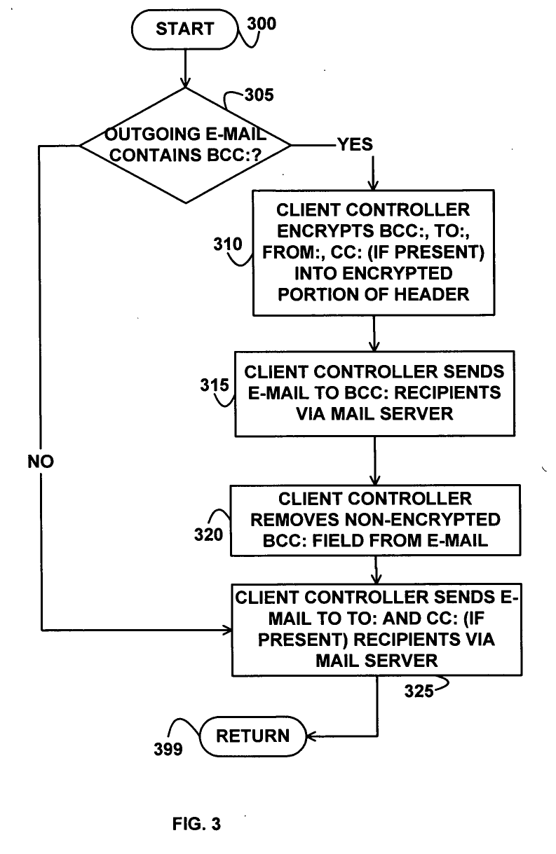

The controller 170 includes instructions capable of executing on a processor (analogous to the processor 101) or statements capable of being interpreted by instructions executing on the processor to perform the functions as further described below with reference to FIG. 3. In another embodiment, the controller 170 may be implemented in microcode or firmware. In another embodiment, the controller 170 may be implemented in hardware via logic gates and/or other appropriate hardware techniques in lieu of or in addition to a processor-based system.

It should be understood that FIG. 1 is intended to depict the representative major components of the computer system 100, the network 130, and the clients 132 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100 and/or the clients 132, and that, when read and executed by one or more processors 101 in the computer system 100 and/or the clients 132, cause the computer system 100 and/or the clients 132 to perform the steps necessary to execute steps or elements comprising the various aspects of an embodiment of the invention.

Moreover, while embodiments of the invention have and hereinafter will be described in the context of fully-functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 and/or the clients 132 via a variety of tangible signal-bearing media, which include, but are not limited to the following computer-readable media:

(1) information permanently stored on a non-rewriteable storage medium, e.g., a read-only memory storage device attached to or within a computer system, such as a CD-ROM, DVD-R, or DVD+R;

(2) alterable information stored on a rewriteable storage medium, e.g., a hard disk drive (e.g., the DASD 125, 126, or 127), CD-RW, DVD-RW, DVD+RW, DVD-RAM, or diskette; or

(3) information conveyed by a communications or transmissions medium, such as through a computer or a telephone network, e.g., the network 130.

Such tangible signal-bearing media, when carrying or encoded with computer-readable, processor-readable, or machine-readable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2A depicts a block diagram of an example e-mail 162-1, as initially created at the client 132, according to an embodiment of the invention. The e-mail 162-1 is an example of the e-mail 162 (FIG. 1). The e-mail 162-1 includes a body 205-1 and a header 210-1. The e-mail 162-1 may also include any other appropriate unillustrated components, such as an envelope, which is ordinarily not viewed by users; instead, the envelope is used internally by the mail server 160 to route the e-mail.

The body 205-1 is the message or content of the e-mail 162-1. The header 210-1 is generated by the controller 170 that first sends the e-mail 162-1 and by all mail servers 160 in route to the destination client. Each mail server 160 and controller 170 that sends, forwards, routes, or receives the e-mail 162-1 may add more information to the header 210-1. The header 210-1 may include a variety of fields, such as: TO (specifying the intended recipient), FROM (specifying the sender), BCC (specifying recipients whose identity is not to be disclosed to other recipients), CC (carbon copy) SUBJECT, DATE, and any number of others. In an embodiment, the header 210-1 includes key: value pairs that conform to RFC (Request for Comments) 822, but in other embodiments any appropriate standard, syntax, or protocol may be used. In the example shown, the recipients of the e-mail 162-1 are illustrated in the header 210-1 in the TO field as Ted, Thelma, and Tim, in the CC field as Carl and in the BCC field as Brad. Further, the sender of the e-mail 162-1 is illustrated in the header 210-1 in the FROM field as Frank.

The header fields and data illustrated in FIG. 2A are examples only, and in other embodiments any appropriate data and fields may be used. Further, the header 210-1 may include more or fewer fields than those illustrated. For example, the TO field may specify one or any number of recipients, and the CC field is optional and may have zero, one, or any number of recipients.

FIG. 2B depicts a block diagram of the example e-mail 162-2, which is the result of modifications to the e-mail 162-1 (FIG. 2A) by the controller 170 prior to sending the e-mail to the recipients via the mail server 160, according to an embodiment of the invention. The e-mail 162-2 is an example of the e-mail 162 (FIG. 1).

Since the header 205-1 of the e-mail 162-1 (FIG. 2A) included a blind carbon copy field (BCC in this example), the controller 170 removed the blind carbon copy field from the header 210-2 and encrypted the FROM, CC fields, and BCC fields (indicating the recipients) and encrypted the TO field (indicating the sender) into the encrypted portion 215 of the header 210-2 prior to sending the e-mail 162-2 to the recipients via the mail server 160, as further described below with reference to FIG. 3. The fields in the header 210-2 that are not in the encrypted portion 215 are not encrypted and are considered to be in a non-encrypted portion of the header 210-2. The controller 170 further removed the BCC field from the header 210-2. The header fields and data illustrated in FIG. 2B are examples only, and in other embodiments any appropriate data and fields may be used.

FIG. 2C depicts a block diagram of an example e-mail 162-3, according to an embodiment of the invention. The e-mail 162-3 is associated with the e-mail 162-2 (FIG. 2B), in that one of the recipients of the e-mail 162-2, in various embodiments, requested a forward of or reply to the e-mail 162-2, which caused the controller 170 to create the e-mail 162-3. The e-mail 162-3 is an example of the e-mail 162 (FIG. 1). The e-mail 162-3 includes a body 205-3 and a header 210-3. The body 205-3 includes selected portions of the e-mail 162-2.

As illustrated in the header 210-3, the sender of the e-mail 162-3 is Ted (indicated in the FROM field) and the recipients are Frank (indicated in the TO field), Thelma, Tim, and Carol (all indicated in the CC field). In response to receiving the e-mail 162-3, the mail server 160 determines that the header 210-3 contains the encrypted portion 215 and that the e-mail 162-3 is between users specified in the non-encrypted TO, FROM, and CC fields, who are also listed in the encrypted portion 215. (The fields in the header 210-3 that are not in the encrypted portion 215 are not encrypted and are considered to be in a non-encrypted portion of the header 210-3.) For example, Frank is both the non-encrypted TO recipient and the encrypted FROM sender; Ted is both the non-encrypted FROM sender and one of the encrypted TO recipients; Thelma is both a non-encrypted CC recipient and an encrypted TO recipient; Tim is both a non-encrypted CC recipient and an encrypted TO recipient; and Carl is both a non-encrypted CC recipient and an encrypted CC recipient. In response to this determination, the mail server 160 sends the e-mail 162-3 to the recipients specified in the non-encrypted header (Frank, Thelma, Tim, and Carl) and to the BCC recipient (Brad) specified in the encrypted portion 215 of the header 210-3.

FIG. 3 depicts a flowchart of example processing for the controller 170, according to an embodiment of the invention. Control begins at block 300. Control then continues to block 305 where the client e-mail controller 170 determines whether an outgoing e-mail 162 contains a blind copy (e.g., BCC) field.

If the determination at block 305 is true, then control continues to block 310 where the client e-mail controller 170 encrypts the BCC field, the TO field, the CC field (if present), and the FROM field into the encrypted portion of the header of the e-mail 162. If the encrypted portion 215 of the header already exists, the client e-mail controller 170 adds additional entries into the encrypted portion 215. The encryption preserves the integrity of the BCC list and prevents the recipients specified in the TO and optional CC fields from viewing the recipients in the BCC field. In an embodiment, the client e-mail controller 170 randomly packs the encrypted field 215, in order to remove indications of whether or not the BCC field is present in the encrypted portion 215. In an embodiment, public/private key encryption is used, but in other embodiments any appropriate type of encryption may be used.

Control then continues to block 315 where the client e-mail controller 170 sends the e-mail 162 to the BCC recipient(s) via the mail server 160.

Control then continues to block 320 where the client e-mail controller 170 removes the non-encrypted BCC field from the header of the e-mail 162. Control then continues to block 325 where the client e-mail controller 170 sends the e-mail 162 to the TO and CC (if present) recipient(s) via the mail server 160. Control then continues to block 399 where the logic of FIG. 3 returns.

If the determination at block 305 is false, then control continues from block 305 to block 325, as previously described above.

FIG. 4 depicts a flowchart of example processing for the mail server 160, according to an embodiment of the invention. Control begins at block 400. Control then continues to block 405 where the mail server 160 receives the e-mail 162. Control then continues to block 410 where the mail server 160 determines whether the received e-mail 162 contains an encrypted portion 215 of the header containing at least a FROM field, a TO field, and a BCC field. If the determination at block 410 is true, then control continues to block 415 where the mail server 160 determines whether the e-mail 162 is between users (specified in a non-encrypted portion of the header) who are also listed in the encrypted portion 215 of the header of the e-mail 162.

If the determination at block 415 is true, then control continues to block 420 where the mail server 160 sends the e-mail 162 to the recipients specified in the non-encrypted header (the non-encrypted TO field and CC field if present) and also sends the e-mail 162 to the recipients specified in the BCC field in the encrypted portion 215 of the header of the e-mail 162. Control then continues to block 499 where the logic of FIG. 4 returns.

If the determination of block 415 is false, then control continues from block 415 to block 425 where the mail server 160 sends the e-mail 162 to the recipient(s) specified in the TO field and optionally the CC field of the non-encrypted portion of the header of the e-mail 162. Control then continues to block 499 where the logic of FIG. 4 returns.

If the determination at block 410 is false, then control continues from block 410 to block 425, as previously described above.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of embodiments of the invention. But, the invention may be practiced without these specific details. In other instances, well-known circuits, structures, and techniques have not been shown in detail in order not to obscure the invention.

What is claimed is:

1. A method comprising:
determining that a second e-mail is associated with a first e-mail and that one of a plurality of recipients of the first e-mail was a blind-copy recipient; and
in response to the determining, sending the second e-mail to the blind-copy recipient of the first e-mail.

2. The method of claim 1, wherein the second e-mail comprises a reply to the first email.

3. The method of claim 1, wherein the second e-mail comprises a forward of the first e-mail.

4. The method of claim 1, wherein the determining further comprises:
determining that the second e-mail comprises an encrypted portion.

5. The method of claim 4, wherein the determining further comprises:
determining that the encrypted portion of the second e-mail comprises an identification of the blind-copy recipient of the first e-mail.

6. The method of claim 4, wherein the determining further comprises:
determining that the second e-mail is between a plurality of users who are also specified in the encrypted portion of the second e-mail.

7. The method of claim 1, wherein the blind-copy recipient of the first e-mail was not identified in the first e-mail to the other of the plurality of recipients of the first e-mail.

8. The method of claim 1, further comprising:
detecting that one of the plurality of recipients of the first e-mail is a blind-copy recipient; and
in response to the detecting, encrypting identification of a sender of the first e-mail and the plurality of recipients into an encrypted portion of the first e-mail.

9. A signal-bearing medium encoded with instructions, wherein the instructions when executed comprise:
determining that a second e-mail is associated with a first e-mail and that one of a plurality of recipients of the first e-mail was a blind-copy recipient, wherein the determining further comprises determining that the second e-mail is between a plurality of users who are also specified in an encrypted portion of the second e-mail; and
in response to the determining, sending the second e-mail to the blind-copy recipient of the first e-mail.

10. The signal-bearing medium of claim 9, wherein the second e-mail comprises a reply to the first email.

11. The signal-bearing medium of claim 9, wherein the second e-mail comprises a forward of the first e-mail.

12. The signal-bearing medium of claim 9, wherein the determining further comprises:
determining that the encrypted portion of the second e-mail comprises an identification of the blind-copy recipient of the first e-mail.

13. The signal-bearing medium of claim 9, wherein the blind-copy recipient of the first e-mail was not identified in the first e-mail to the other of the plurality of recipients of the first e-mail.

14. The signal-bearing medium of claim 9, further comprising:
detecting that one of the plurality of recipients of the first e-mail is a blind-copy recipient; and
in response to the detecting, encrypting identification of a sender of the first e-mail and the plurality of recipients into an encrypted portion of the first e-mail.

15. A method for configuring a computer, comprising:
configuring the computer to determine that a second e-mail is associated with a first e-mail and that one of a plurality of recipients of the first e-mail was a blind-copy recipient, wherein the configuring the computer to determine further comprises configuring the computer to determining that the second e-mail is between a plurality of users who are also specified in an encrypted portion of the second e-mail; and
configuring the computer to, in response to the determining, send the second e-mail to the blind-copy recipient of the first e-mail.

16. The method of claim 15, wherein the second e-mail comprises a reply to the first email.

17. The method of claim 15, wherein the second e-mail comprises a forward of the first e-mail.

18. The method of claim 15, wherein the configuring the computer to determine further comprises:
configuring the computer to determine that the encrypted portion of the second e-mail comprises an identification of the blind-copy recipient of the first e-mail.

19. The method of claim 15, wherein the blind-copy recipient of the first e-mail was not identified in the first e-mail to the other of the plurality of recipients of the first e-mail.

20. The method of claim 15, further comprising:
configuring the computer to detect that one of the plurality of recipients of the first e-mail is a blind-copy recipient; and
configuring the computer to, in response to the detecting, encrypt identification of a sender of the first e-mail and the plurality of recipients into an encrypted portion of the first e-mail.
